(19) United States
(12) Patent Application Publication
(10) Pub. No.: US 2007/0001101 A1
(43) Pub. Date: Jan. 4, 2007

(54) Programmable rise/fall time control circuit

(75) Inventors: Raj Sundararaman, Mission Viejo, CA (US); Chi-Shao Sergi Lin, Mission Viejo, CA (US); Jiafu Luo, Irvine, CA (US); Richard Mann, Torrance, CA (US); Zeynep Toros, Aliso Viejo, CA (US)

Correspondence Address: STEVENS LAW GROUP, P.O. BOX 1667, SAN JOSE, CA, 95109, US

(73) Assignee: ESS Technology, Inc., Fremont, CA (US)

(21) Appl. No.: 11/238,425

(22) Filed: Sep. 28, 2005

Related U.S. Application Data
(60) Provisional application No. 60/696,129, filed on Jul. 1, 2005.

(51) Int. Cl. H01J 40/14

(52) U.S. Cl. 250/214 R

(57) ABSTRACT

An electronic device is provided such as a programmable rise/fall time control circuit, for example, that delivers a continuous and near linear rising/falling slope of a control signal, with programmability that can be implemented in future CMOS image sensor devices. This device includes a programmability block for reset or transfer gate signals. The programmability block includes two inputs: an input bias current and a signal from the control bits. The programmability block further includes two similar internal circuit blocks, one for generating a fall time control signal, and one for generating a rise time control signal. Additionally the programmability block includes two outputs; a fall time control signal, and a rise time control signal. The device further includes a reset or transfer gate buffer configured as an inverter. The reset or transfer gate buffer includes three input signals: The fall time control signal and rise time control signal from the programmability block, and an INT Reset signal. Furthermore, the reset or transfer gate buffer includes an output reset or transfer gate signal. The device is configured to take an input bias current, and by controlling the transconductance of internal circuitry provide a tapered rise and fall time signal to a reset or transfer gate of a CMOS image sensor that is programmable.

### RELATED APPLICATIONS

This application is a conversion of U.S. Provisional Patent Application Ser. No. 60/696,129, filed on Jul. 1, 2005.

### BACKGROUND

This invention generally relates to CMOS image sensor devices, and more particularly to programmable circuits to control the rise and fall time signal to a reset or transfer gate of a CMOS image sensor

CMOS imagers are increasingly being used as low cost imaging devices. A conventional CMOS image sensor circuit includes a focal plane array of pixel cells, where each pixel cell consists of a photo gate, photoconductor, or photodiode, that has an associated charge accumulation region within a substrate. This is for accumulating a photo-generated charge. Each pixel cell may include a transistor for transferring a charge from the charge accumulation region to a sensing node, and a transistor for resetting a sensing node to a predetermined charge level prior to charge transference.

An example of an image sensor is a 4T CMOS image sensor. FIG. 1 below shows an electron-collecting pixel with NMOS transfer gate. The transfer gate (“TG”) signal is a signal transmitted via a TG line that controls the transfer gate device. The transfer gate is connected via the TG line to sensitive signal nodes such as a photodiode and floating diffusion. The signal is so sensitive that it is accounted for at the electron level, where an abrupt switching of the transfer gate via the TG line could cause unwanted disturbance to sensitive signal nodes like floating diffusion and photo diodes. (Please refer to FIG. 1)

One such problem that conventional devices do not address would be an incomplete charge transfer. FIG. 2 is a diagrammatical representation of a conventional pinned-photodiode 4T pixel structure. The charge transfer may be achieved through the potential difference between pinning potential, which is the lowest voltage of the photodiode required to achieve full depletion, and the floating diffusion node, which is on the other side of the transfer gate device. Also, the charge transfer may be achieved through the repelling force among carriers of same polarity, electrons in this case, inside the photodiode. As the process of charge transfer gets closer to the end, it becomes more difficult for electrons to get out because the difference of potential between photodiode and floating diffusion decreases. This occurs as a result of the transferred charge, or the repelling force inside the photodiode, is weakened, which occurs because most of the electrons have been transferred. In the end, electron thermal diffusion dominates the charge transfer process. As a result, an abrupt closing of transfer gate by control signal TG can potentially disturb the delicate process.

Another problem caused by an abrupt switching of the TG line that conventional devices do not address is excessive charge injection. In this situation, a layer of conducting carriers is formed underneath the transfer gate when it is turned on for charge transfer. While turning off the charge transfer gate, these charges will go to either the floating diffusion or to the photodiode, as shown in FIG. 3. Ideally, these charges should go to the floating diffusion, because of the potential difference, assuming that it is not saturated. However, an abrupt falling of a control signal to turn off the transfer gate might cause some charges to flow back to the photodiode.

Furthermore, another problem caused by an abrupt switching of the TG line that conventional devices do not address is excessive clock feed through. When an abrupt change of control signal happens, it disturbs the potential levels of the photodiode and the floating diffusion through the parasitic capacitors. It changes the delicate balance between potentials necessary for charge transfer process.

Similar problems might occur if a PMOS TG is used. In such a configuration, the pixel cell is configured to collect holes instead of electrons. In such a configuration, however, it would be the ‘rising edge’ of signal TG that could produce the undesirable results. In this or other conventional configurations, it would be desirable to have a mild, tapered falling or rising signal of the control signal TG. This would prevent abrupt or unexpected switching of the TG line.

Therefore there exists a need for a device that addresses the problems of conventional devices. As will be seen below, the invention accomplishes this in an elegant manner.

### BRIEF DESCRIPTION OF THE DRAWINGS

FIG. 1 shows a schematic representation of a typical 4-T Pixel of a CMOS Image Sensor (Background);

FIG. 2 shows a diagrammatic representation of a charge transfer between a photodiode and floating diffusion (Background);

FIG. 3 shows a diagrammatic representation of charge transfer during a transfer gate signal turning off (Background);

FIG. 4 is a diagrammatic view of a programmable rise/fall circuit according to one embodiment of the invention;

FIG. 5 is a diagrammatic view of the fall time control circuit block internal to the rise time/fall time programmability block of FIG. 4;

FIG. 6 is a diagrammatic view of the rise time control circuit block internal to the rise time/fall time programmability block of FIG. 4; and

FIG. 7 is a diagrammatic view of a reset or transfer gate buffer block according to the invention.

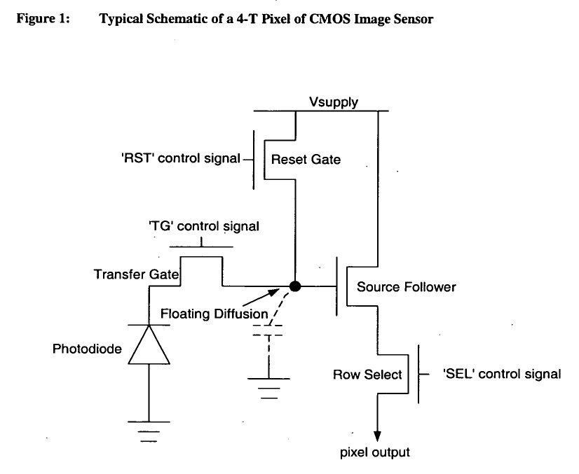

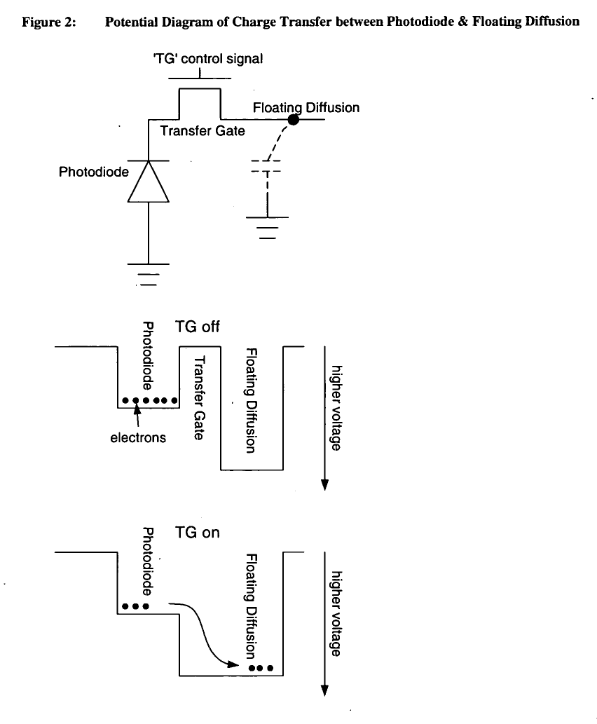

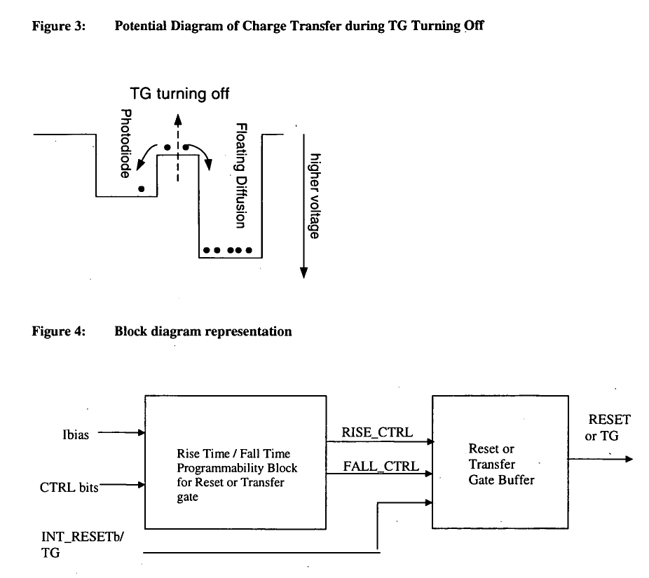

### DETAILED DESCRIPTION

In addressing the problems of the prior art, the invention is directed to a programmable rise and/or fall time control circuit that delivers a continuous and substantially linear rising and/or falling slope of a control signal. Furthermore, the invention provides a circuit that may be programmable and that can be implemented in conventional as well as future CMOS image sensor devices. This addresses the problem of abrupt switching of the transfer gate (TG) line. Tapered rise/fall time control is very useful when a controlled switch is connected to a node with a sensitive signal to prevent incomplete charge transfer, excessive charge injection, and clock feed-through due to fast switching of control line which can lead to disturbance and excessive noise on sensitive nodes thus causing deterioration in performance. Programmability of the slope makes it even more useful to adopt variations due to different designs and process. In one embodiment, a circuit configured with the invention includes a programmability circuit configured for processing input signals, in particular an input bias current, control bits from a controller, and a TG or reset signal, and generating reset or transfer gate signals in a novel an advantageous manner.

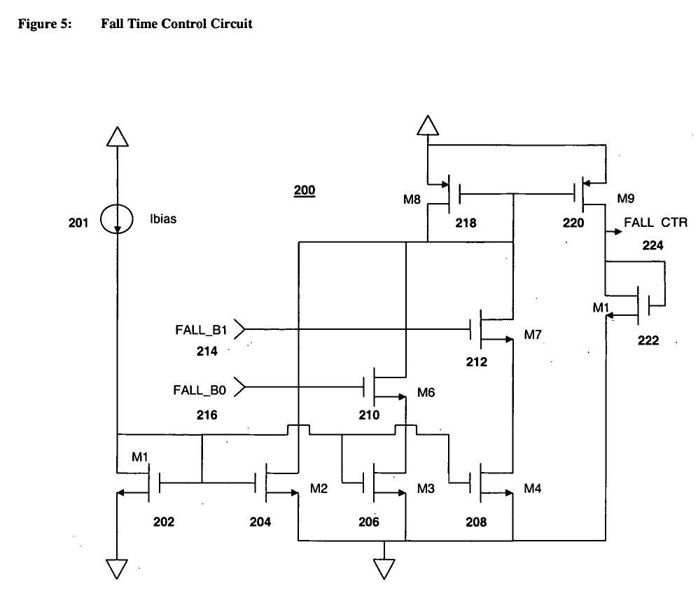

Referring to FIG. 4, a diagrammatic view of a control circuit according to one embodiment of the invention is illustrated. The Rise Time/Fall Time Programmability Block receives two inputs. One is an input bias current and the other a signal from a controller to receive the control bits. The control bits are digital bit signals generated from a control module, which may be a conventional controller, such as a logic circuit configured with hardware such as serial ports and registers, software, or a combination of the two. This is also true of the TG signals “NT_TG and reset bits “INT_RESETh”, to the buffer circuit. The invention is not limited to any particular controller, and those skilled in the art will understand that many controllers exist that can be configured to perform such functions. The Reset or Transfer Gate Buffer is configured to receive two signals, RISE_CTRL and FALL_CTRL. These signals are used by the Reset or Transfer Gate Buffer to produce controlled reset and transfer gate signals, as is discussed in more detail below.

The programmability block, or any entity described herein as a block may be a control unit, for example, that is simply hardware enabled logic circuitry configured to produce a processed output in response to a provided input. In one example, a control unit may be a serial port with registers, 8-bit registers for example, that can be programmed by software commands from a state machine. Those skilled in the art will understand that there are other configurations are possible without departing from the spirit and scope of the invention, which is defined by the appended claims.

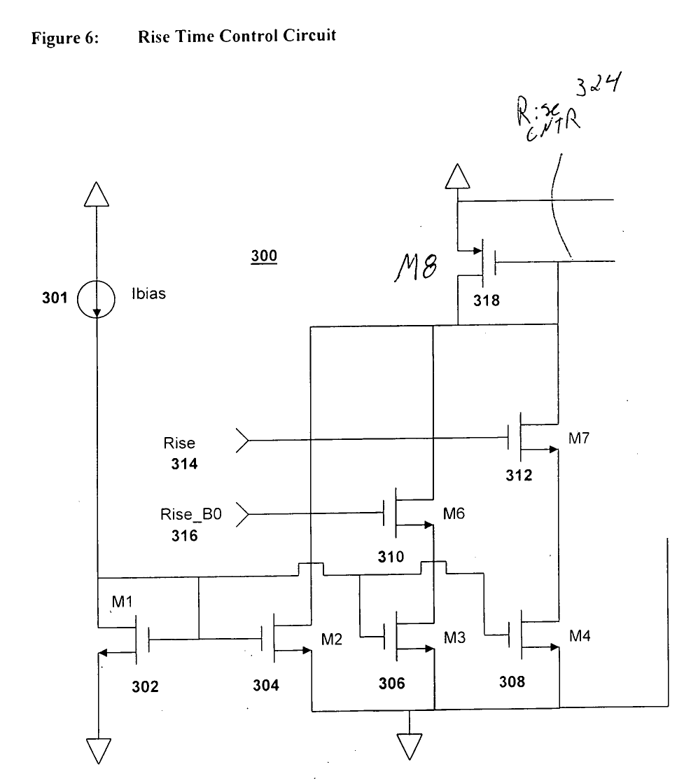

There are two control circuit blocks internal to the programmability block that are similar in function, one control block is for generating a fall time control signal, and the other is for generating a rise time control signal. Each of these circuits is illustrated in more detail in FIGS. 5 and 6 respectively and described in more detail below. Additionally, there are two outputs that are generated from these circuits within programmability block to a reset or transfer gate buffer, one is a fall time control signal, and the other is rise time control signal. These serve as inputs to a reset or transfer gate buffer. This buffer may be configured as an inverter for generating an output reset or transfer gate signal.

Again, as discussed in the background, in conventional devices, the rise and fall times of the control signals are controlled by adjusting the driver buffer device sizes. A circuit configured according to the invention provides a single rise and fall time for a given circuit that takes into account design and process variations. Furthermore, a circuit configured according to the invention addresses these needs by controlling the slope of the control signal by the transconductance of MOSFETs as discussed further below.

As further background, the general concept of transconductance, also known as mutual conductance, is a property of certain electronic components. It is a contraction of “transfer conductance”. Conductance is the flow of a current through two points when a voltage is applied as in a resistor, conductance being the reciprocal of resistance. In contrast, transconductance is the control of a current through two output points by a voltage at two input points, as if the conductance is transferred from the input points to the output points. In field effect transistors, transconductance is the change in the drain/source current divided by the change in the gate/drain voltage with a constant drain/source voltage. In this case the transconductance of the MOSFET is directly proportional to the square root of the current of MOSFET. Generally, the higher the transconductance, the faster the transition from logic HIGH to logic LOW. In terms of the art, the result is a smaller rise or fall time. Thus with different combinations of two control signals, the rise or fall time of the output of the buffer can be varied.

The invention enables a novel circuit configuration that produces a tapered rise and fall time signal to a reset or transfer gate of a CMOS image sensor. Furthermore, in one embodiment, this rise and fall time is programmable by controlling the transconductance of internal MOSFET circuitry. This circuit provides a very useful as well as an economical solution in generating a continuous and substantially linear rising and/or falling slope of a control signal. The programmability prevents the occurrence of incomplete charge transfers, excessive charge injections, and clock feed-through due to fast switching of control lines. This prevents the resulting disturbance and excessive noise that conventional circuits suffer from on sensitive nodes, resulting in little or no deterioration in circuit performance. The result is better circuit performance with substantially less tendency to deteriorate.

In one embodiment, the invention provides a circuit configured to enable the programmability for the rise and fall times of reset and transfer gate signals that are inputs to active pixels, such as inputs to a standard a four-transistor active pixel, which is commonly employed in CMOS image sensors. In this embodiment, and referring to FIG. 4, a block diagram representation of such a circuit is illustrated. The circuit consists of a programmability block that takes an input bias current and provides an output current that is a multiple of the input current depending on the status of the control bits. Two similar blocks are used—one for fall time control and the other for rise time control as shown in FIGS. 5 and 6.

Referring to FIG. 5, one embodiment of the invention is illustrated, where the Fall Control circuit 200 is configured with three inputs for receiving input signals, and an output for outputting an output signal. A bias current source 201 and a transistor M1 202 are connected between a reference voltage and ground. Transistor M1 202 is configured to be a current mirror with transistor M2 204, transistor M3 206, and transistor M4 208. Transistor M2 204 is configured to transmit current directly to the drain of transistor M8 218. Transistor M3 206 is connected to the source of transistor M6 210. The gate of transistor M6 210 is configured to receive a control signal FALL_B0 216. If the control signal FALL_B0 216 is at a logic HIGH, then transistor M6 210 is turned on allowing the current from transistor M3 206 to flow into the drain of transistor M8 218, and be added to the current from transistor M2 204. Furthermore, transistor M4 208 is connected to the source of transistor M7 212. The gate of transistor M7 212 is configured to receive a control signal FALL_B1 214. If the control signal FALL_B1 214 is at a logic HIGH, then transistor M7 212 is turned on allowing the current from transistor M4 208 to flow into the drain of transistor M8 218, and be added to the current from transistor M2 204. Transistor M9 220 is configured as a current mirror to transistor M8 218. The current through transistor M9 220 delivers an output signal FALL_CTRL 224, and is transmitted to transistor M10 222. Transistor M10 222 is configured as a current mirror to a transistor in the Reset or Transfer Gate Buffer circuit.

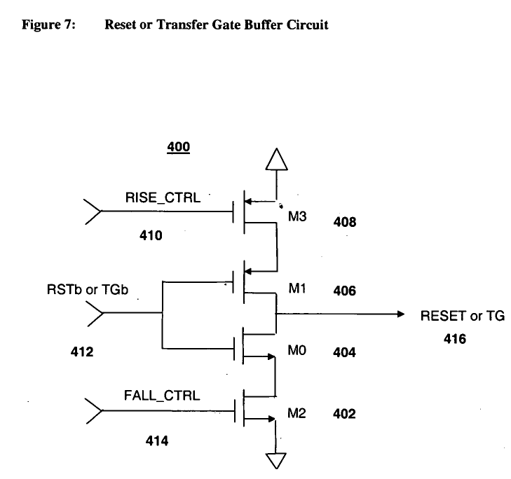

Referring to FIG. 6, another embodiment of the invention is illustrated, where the Rise Control circuit 300 is configured with three inputs for receiving input signals, and an output for outputting an output signal. A bias current source 301 and a transistor M1 302 are connected between a reference voltage and ground. Transistor M1 302 is configured to be a current mirror with transistor M2 304, transistor M3 306, and transistor M4 308. Transistor M2 304 is configured to transmit current directly to the drain of transistor M8 318. Transistor M3 306 is connected to the source of transistor M6 310. The gate of transistor M6 310 is configured to receive a control signal RISE_B0 316. If the control signal RISE_B0 316 is at a logic HIGH, then transistor M6 310 is turned on allowing the current from transistor M3 306 to flow into the drain of transistor M8 318, and be added to the current from transistor M2 304. Furthermore, transistor M4 308 is connected to the source of transistor M7 312. The gate of transistor M7 312 is configured to receive a control signal RISE_B1 314. If the control signal RISE_B1 314 is at a logic HIGH, then transistor M7 312 is turned on allowing the current from transistor M4 308 to flow into the drain of transistor M8 318, and be added to the current from transistor M2 304. Transistor 318 delivers an output signal RISE_CTRL 324. The outputs from this block called RISE_CTRL are then transmitted to a buffer, such as that illustrated in FIG. 7, which is basically an inverter whose speed of transitions from logic HIGH to LOW or vice versa are controlled by transconductance.

Referring to FIG. 7, the output circuit of one embodiment of the invention is illustrated, where the Reset or Transfer Gate Buffer circuit 400 is configured with three inputs for receiving input signals, and an output for outputting an output signal. The circuit of FIG. 7 would be duplicated for each of the TG and Reset functions, where the output buffer is configured to receive control signals from the TG (INT_TG) as well as the RESET (RESETh) from a controller. A transistor M2 402, receives a FALL_CTRL signal 414 from an input to the circuit 400, and is configured as a current mirror to a transistor M1 222 (FIG. 5) in the Fall Control circuit which controls the flow of current in transistor M2 402. The drain of transistor M2 402 is connected to the source of transistor M0 404. The gate of transistor M0 404 receives an input signal RESETh 412. When both the FALL_CTRL signal 414 signal and the RESETh 412 signal are both at logic HIGH, then transistor M0 404 turns on allowing the current from transistor M2 402 to flow to the output RESET or TG 416. The transconductance in transistor M2 402 determines the speed of the fall time of the output signal RESET or TG 416. Similarly, transistor M3 408, receives a RISE_CTRL signal 410 from an input to the circuit 400, and is configured as a current mirror to a transistor in the Rise Control circuit which controls the flow of current in transistor M3 408. The drain of transistor M3 408 is connected to the source of transistor M1 406. The gate of transistor M1 406 receives an input signal RESETh 412. When both the RISE_CTRL signal 410 signal and the RESETh 412 signal are both at logic LOW, then transistor M1 406 turns on allowing the current from transistor M3 408 to flow to the output RESET or TG 416. The transconductance in transistor M3 408 determines the speed of the rise time of the output signal RESET or TG 416.

FIG. 5 shows the circuit diagram that produces the control signal FALL_CTRL. M2, M3 and M4 form a current mirror with M1 which carries the input bias current, Ibias. The relationship between the amount of current carried by each one of M2, M3 and M4 is related to Ibias by the ratio of the aspect ratios of the dimensions of these transistors with respect to M1. In other words,
I_{M2}Ibias=(W/L)_{M2}/(W/L)_{M1}

While the current from M2 is directly fed in to the MOSFET M8, the currents from M3 and M4 will be added in to M8 depending on the status of the two control signals, FALL_B0 and FALL_B1. If they are at logic HIGH, they turn on the two MOSFET transistors, M6 and M7 respectively and thus provide a path for the currents from M3 and M4 to flow in to the drain of M8. The current through M8 is mirrored on to M9 and flows in to M10. M10 is then mirrored with M2 in the buffer (FIG. 7) and thus controls the current flowing in M2. The transconductance of M2 is directly proportional to the square root of the current of M2. Thus, the higher the transconductance, the faster the transition from LOGIC HIGH to logic LOW. In terms of the art, the result is a smaller fall time. Thus with different combinations of the two control signals, FALL_B0 and FALL_B1, the fall time of the output of the buffer can be varied. The rise time control is similarly generated using the rise time control circuit in FIG. 6 from transistor M8 in conjunction with the MOSFET M3 in the buffer in FIG. 7. The above circuit uses two control bits each for rise time and fall time but need not be limited to this number.

The invention has been described above in terms of a programmable rise and fall circuit, including embodiments of an electronic device that controls the rise and fall times of a reset and transfer gate signal that includes a control circuit configured to produce control signals for controlling the rise time and fall time signals to a reset or transfer gate of a CMOS image device; and a reset and transfer gate buffer configured to produce output reset and transfer gate control signals having controlled rise and fall time slopes in response to the control signal produced by the control circuit. Those skilled in the art, however, will understand that insubstantial changes may be made to these embodiments without departing from the spirit and scope of the invention, which is defined by the appended claims and their equivalents.

1. An electronic device that controls the rise and fall times of a reset and transfer gate signal, comprising:
a control circuit configured to produce control signals for controlling the rise time and fall time signals to a reset or transfer gate of a CMOS image device, and
a reset and transfer gate buffer configured to produce output reset and transfer gate control signals having controlled rise and fall time slopes in response to the control signal produced by the control circuit.

2. A device according to claim 1, wherein the output of the reset and transfer gate buffer is configured to output a signal to a transfer gate and reset gate of a CMOS image device.

3. A device according to claim 1, wherein the control circuit is configured to generate a rise and fall time for a given circuit that is controlled according to design and process variations.

4. A device according to claim 1, wherein the control circuit is configured to control the slope of the control signal via the transconductance of the transistors configured within the control circuit.

5. An electronic device according to claim 1, wherein the transistors are MOSFET transistors, and wherein the transconductance of the transistors cause the rise and fall times to be tapered.

6. An electronic device according to claim 1, wherein the slopes indicative of rise and fall times are tapered.

7. An electronic device according to claim 1, wherein the slope indicative of the tapered rise time and fall time signals are programmable.

8. An electronic device according to claim 1 wherein the rise time and fall time programmability block consists of two similar internal blocks configured to provide a rise time control signal and a fall time control signal.

9. An electronic device according to claim 3 wherein the reset and transfer gate buffer is configured to receive the rise time and fall time control signals and output a programmable rise time and fall time signals to a reset gate.

10. An electronic device according to claim 3 wherein the reset and transfer gate buffer is configured to receive the rise time and fall time control signals and output a programmable rise time and fall time signals to a transfer gate.

11. An electronic device according to claim 10 wherein the programmability of the output signal is controlled by the transconductance of MOSFETs internal to the reset and transfer gate buffer.

12. An electronic device according to claims 1, wherein the device may be implemented in CMOS image sensor devices.

13. An electronic device according to claims 1, wherein the device is configured with programmability of the slope of the rise time and fall time signals to adopt variations due to different designs and processes.
